(19) United States
(12) Patent Application Publication
(10) Pub. No.: US 2011/0107754 A1
(43) Pub. Date: May 12, 2011

(54) HYDRAULIC HYBRID TRANSMISSION RETARD DEVICE

(76) Inventors: James A. O'Brien, La Salle, MI (US); Richard T. Hoehn, Defiance, OH (US)

(21) Appl. No.: 12/863,048

(22) PCT Filed: Jan. 15, 2009
(86) PCT No.: PCT/US09/31063

§ 371 Date: Jan. 21, 2011

Related U.S. Application Data
(60) Provisional application No. 61/021,079, filed on Jan. 15, 2008.

(51) Int. Cl. F16H 39/00; F16F 9/24

(52) U.S. Cl. 60/327; 188/297; 60/413

(57) ABSTRACT

A retard device (100, 100′) for a hybrid system (2) is provided. The retard device (100, 100′) includes a housing (102, 102′) having a first end (104, 104′) and a second end (106, 106′). The first end (104, 104) has a system inlet (108, 108) and the second end (106, 106) has an aperture (110, 110′). A piston assembly (112, 112′) is slidably disposed in the aperture (110, 110′) of the housing (102, 102′). The piston assembly (112, 112′) includes a piston head (114, 114′) coupled to an actuating linkage (116, 116). The piston head (114, 114′) is disposed adjacent the system inlet (108, 108) and the actuating linkage (116, 116′) is disposed through the aperture (110, 110) of the housing (102, 102′). A spring (126, 126) is disposed within the housing (102, 102′) between the second end (106, 106′) and the piston head (114, 114′). The piston head (114, 114′) is biased toward the first end (104, 104′) by the spring (126, 126′) and biased toward the second end (106, 106′) by a force applied at the system inlet (108, 108′). A hybrid system (2) and method of using the retard device (100, 100′) are also provided.

### CROSS-REFERENCE TO RELATED APPLICATIONS

This application claims the benefit of U.S. Provisional Application No. 61/021,079, filed on Jan. 15, 2008. The entire disclosure of the above application is hereby incorporated herein by reference.

### FIELD OF THE INVENTION

The present disclosure relates generally to hybrid systems and more particularly to devices and methods for inhibiting hybrid stall in hybrid systems.

### BACKGROUND OF THE INVENTION

Hybrid powertrains are an increasingly popular approach to improving the fuel utilization of motor vehicles. The term “hybrid” refers to the combination of a conventional internal combustion engine with an energy storage system, which typically serves the functions of receiving and storing excess energy produced by the engine and energy recovered from braking events, and redelivering this energy to supplement the engine when necessary. This decouples the production and consumption of power, thereby allowing the internal combustion engine to operate more efficiently, while making sure that enough power is available to meet load demands.

As described by O'Brien II et al. in High Efficiency Hydraulic Hybrid Drive System for Mobile Applications, presented at CONEXPO-CONAGG 2008, Las Vegas, Nev. (March 2008), the entire disclosure of which is hereby incorporated herein by reference, known types of hybrid powertrains include parallel hybrids and series hybrids. With parallel hybrids, a traditional engine-powered transmission exists in parallel with a secondary transmission. This provides the ability for either an engine or an energy storage device to propel a vehicle independent of, or simultaneously with, the other. Referring to FIG. 1, a series hybrid system 2 includes a power plant 4, typically with an engine 6 and a pump 8, an energy store 10 such as an accumulator, a drive motor 12, and drive wheels 14. With series hybrid systems 2, the engine-powered transmission is absent, and the engine 6 is instead used to maintain a level of energy within the energy store 10. The stored energy is used to propel the vehicle. The series hybrid configuration allows the power generation and power consumption systems to be decoupled, allowing each to be controlled in an optimized manner.

An illustrative series hydraulic hybrid powertrain system is disclosed in U.S. Pat. No. 7,281,376 to O'Brien II, the entire disclosure of which is hereby incorporated herein by reference. The hydraulic hybrid power system includes a power plant generating a high pressure fluid at an output. The power plant includes an engine such as a conventional internal combustion engine, a turbine engine, an electric motor powered by a battery, a fuel cell, or the like. A drive motor responsive to the high pressure fluid is connected to the engine. The drive motor is in fluid communication via a high pressure conduit with an accumulator that serves as an energy store or reservoir for high pressure hydraulic fluid. A mode selection means is connected to the power plant output and the drive motor for selecting a mode of operation such as a drive mode, a neutral mode, a reverse mode, and a park mode. A control system is connected to the power plant and the drive motor for controlling operation of the drive motor under the desired mode of operation.

In operation, when a driver steps on an accelerator of a vehicle with the hydraulic hybrid powertrain system, a displacement of the drive motor increases and causes additional torque to be produced, thereby propelling the vehicle. The oil flowing through the motors comes from the accumulator, causing the amount of oil stored to be reduced, which in turn lowers the hydraulic hybrid powertrain system pressure. When the pressure falls below a specified minimum value, the engine turns on and drives a hydraulic pump to refuel the accumulator. When a specified pressure is reached, the engine turns off.

One challenge faced by designers of any hybrid system is preventing the energy store from becoming fully depleted, in a phenomenon known as “hybrid stall”. For an electric hybrid system, especially those employing lithium battery chemistries, the depletion of the battery may seriously damage the battery pack. With the hydraulic hybrid system, the depletion of the energy store is also problematic. FIG. 2 shows an exemplary comparison of velocity profile to oil volume profile as a conventional hydraulic hybrid vehicle accelerates rapidly from rest. Typically, in a hydraulic hybrid stall, the accumulator has been emptied and the engine cannot provide sufficient power to both propel the vehicle and recharge the accumulator. In this situation, the system is no longer operating in a pressure control mode, but rather in a flow control mode. To recover from this situation, it is necessary for the conventional hydraulic hybrid vehicle to slow down to allow oil to be stored in the accumulator.

There is a continuing need for a device and method for militating against a stall in a hybrid system, and particularly a hydraulic hybrid powertrain system. Desirably, the device and method enhances the fuel efficiency of the hybrid system.

### SUMMARY OF THE INVENTION

In concordance with the instant disclosure, a device and method for militating against a stall in a hybrid system, and particularly a hydraulic hybrid powertrain system, and that enhances the fuel efficiency of the hybrid system, is surprisingly discovered.

In one embodiment, a retard device includes a housing having a first end and a second end. The first end has a system inlet and the second end has an aperture. A piston assembly is slidably disposed in the aperture of the housing. The piston assembly includes a piston head coupled to an actuating linkage. The piston head is disposed adjacent the system inlet and the actuating linkage is disposed through the aperture of the housing. A spring is disposed within the housing between the second end and the piston head. The piston head is biased toward the first end by the spring and biased toward the second end by a force applied at the system inlet.

In another embodiment, a hydraulic hybrid powertrain system includes at least one drive motor responsive to the fluid flow from at least one of a power plant and an accumulator. A control system is connected to the power plant and the at least one drive motor for controlling operation of the power plant and the at least one drive motor in a plurality of modes of operation. The hydraulic hybrid powertrain system further includes at least one retard device that reduces the fluid flow to the at least one drive motor when the pressure of the fluid in the hydraulic hybrid powertrain system drops below a predetermined minimum pressure.

In a further embodiment, a method for operating a hybrid system includes the steps of: continuously monitoring a pressure of a fluid in the hybrid system, the hybrid system having an at least one drive motor responsive to a fluid flow from at least one of a power plant and an accumulator, a control system connected to the power plant and the at least one drive motor for controlling operation of the power plant and the at least one drive motor in a plurality of modes of operation, and a retard device; comparing the pressure of the fluid in the hybrid system to a predetermined minimum pressure; inhibiting an ability of an operator to demand more power than the hybrid system can provide without stalling by reducing the fluid flow to a drive motor when the predetermined minimum pressure is achieved; and allowing the pressure of the fluid in the hybrid system to recover, wherein a hybrid stall is militated against.

### DRAWINGS

The above, as well as other advantages of the present disclosure, will become readily apparent to those skilled in the art from the following detailed description, particularly when considered in the light of the drawings described herein.

FIG. 1 shows a block diagram of a illustrative series hybrid system of the prior art;

FIG. 2. shows exemplary graphs of velocity and oil volume profiles in a hydraulic hybrid system of the prior art, showing the hydraulic hybrid system under acceleration;

FIG. 3 shows exemplary graphs of velocity and oil volume profiles in a hydraulic hybrid system having the retard device according to the present disclosure, showing the hydraulic hybrid system under acceleration;

FIG. 4 shows an elevational side view of a retard device in accordance with the present disclosure;

FIG. 5 shows a cross-sectional view of the retard device depicted in FIG. 4, taken along section line 5-5;

FIG. 6 shows a partial, perspective view of the retard device depicted in FIGS. 4 and 5 with a control system for a hydraulic hybrid system, further showing an interior of the retard device;

FIG. 7 shows a partial, perspective view of the retard device according to another embodiment of the present disclosure, further showing an interior of the retard device; and

FIG. 8 shows a partial side elevational view of the retard device depicted in FIG. 7.

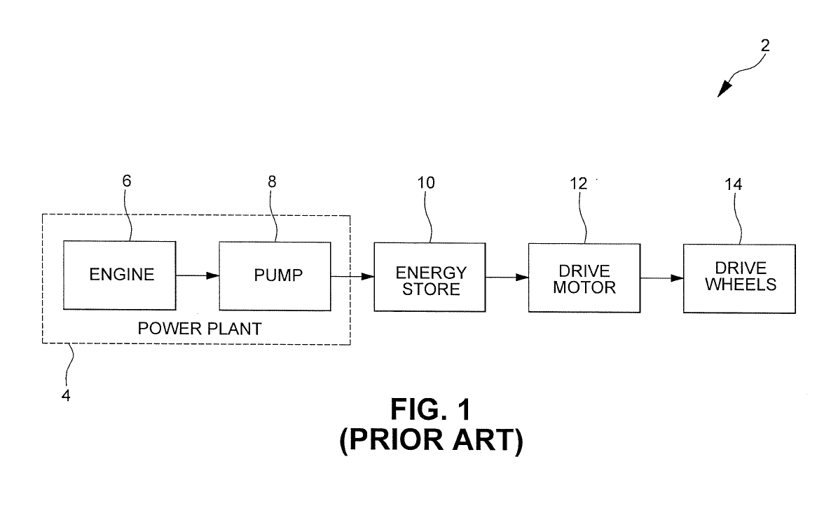

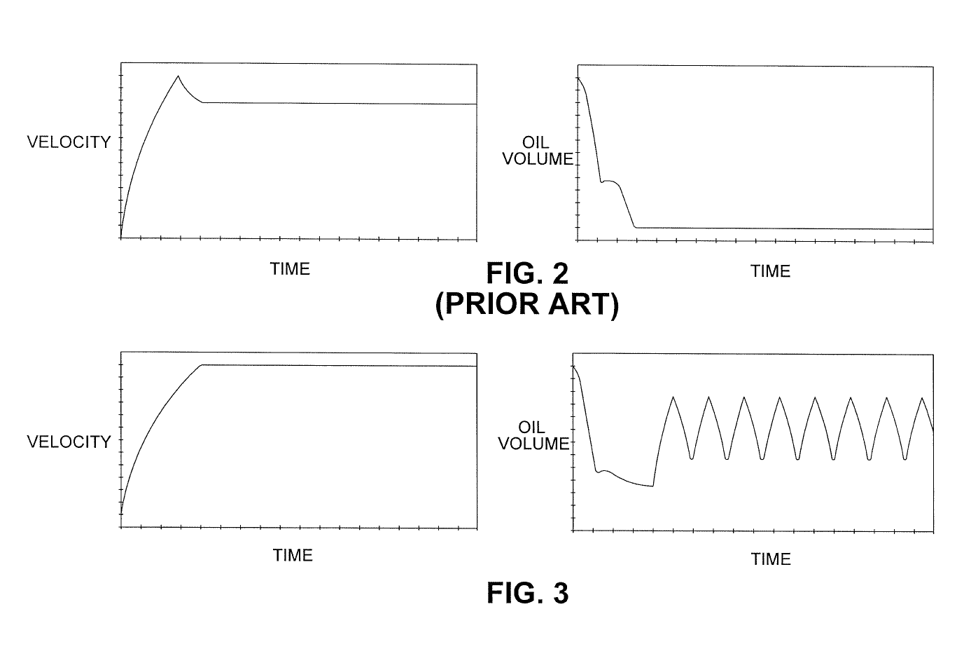

### DETAILED DESCRIPTION OF THE INVENTION

The following description is merely exemplary in nature and is not intended to limit the present disclosure, application, or uses. It should also be understood that throughout the drawings, corresponding reference numerals indicate like or corresponding parts and features. In respect of the methods disclosed, the steps presented are exemplary in nature, and thus, are not necessary or critical.

The present disclosure includes a retard device 100 and method for controlling the drive motors in the hybrid system 2. In particular, the retard device 100 is configured to reduce the flow of a hydraulic fluid, such as oil, from the energy store 10, such as the accumulator, when a system pressure drops below a predetermined minimum pressure. The predetermined minimum pressure is a pressure below which a hybrid stall may occur. The effect of the retard device 100 is to retard the flow of the hydraulic fluid to drive motors 12 and militate against the hybrid stall, particularly by reducing an available displacement of the drive motors 12. Additionally, the retard device 100 facilitates an aggressive and rapid recovery from the hybrid stall, should one occur due to a mechanical malfunction such as a fluid leak and the like.

Referring to FIG. 3, a comparison of velocity profile to oil volume profile by a hydraulic hybrid vehicle with the retard capability of the present invention is shown. As the hydraulic hybrid vehicle accelerates rapidly from rest, the hydraulic hybrid vehicle with the retard capability continues to accelerate until the predetermined minimum pressure of the system is attained. The flow of oil is subsequently reduced, allowing the oil volume to increase, for example, by recharging the energy store 10, and the hydraulic hybrid vehicle to reach the desired velocity without stalling. Although the hydraulic hybrid vehicle having the retard device 100 may have a comparatively lower rate of acceleration compared to known vehicles without retard capability, it should be appreciated that the employment of the retard device 100 desirably minimizes an occurrence of hybrid stall during operation of the hydraulic hybrid vehicle.

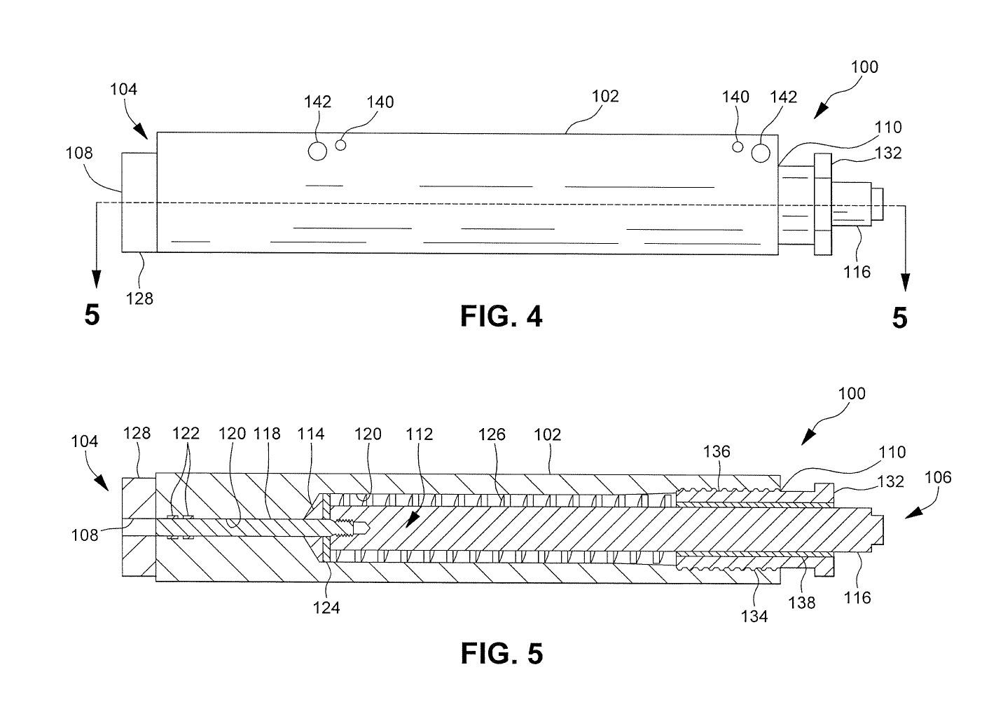

As shown in FIGS. 4 to 6, the retard device 100 according to one embodiment the present disclosure includes a housing 102 having a first end 104 and a second end 106. The first end 104 has a system inlet 108 and the second end has an aperture 110 formed therein. The retard device 100 further includes a piston assembly 112. The piston assembly 112 is slidably disposed in the aperture 110 of the housing 102. The piston assembly 112 may include a piston head 114 coupled to an actuating linkage 116. The piston head 114 may be integrally formed with the actuating linkage 116, for example. The piston head 114 is disposed adjacent the system inlet 108. The actuating linkage 116 is disposed through the aperture 110 of the housing 102.

In a particular embodiment, the piston assembly 112 includes a push rod 118 slidably disposed in the system inlet 108. The push rod 118 may be coupled to the piston head 114. At least one of the push rod 118 and the piston head 114 may sealingly engage an inner surface 120 of the housing 102. For example, the push rod 118 may have at least one primary seal 122 that sealingly engages the inner surface 120 of the housing 102. The push rod 118 may be integrally formed with the piston head 114 and the actuating linkage 116. In one embodiment, the push rod 118 is removably coupled to the piston head 114 and the actuating linkage 116, for example, by a threaded engagement of the push rod 118 with the piston head 114

A spring 126 is disposed within the housing 102 between the second end 106 and the piston head 114. In particular, the spring 126 contacts the piston head 114. The piston head 114 is biased toward the first end 104 by the spring 118 and biased toward the second end 106 by a force applied at the system inlet 108. The force may be at least one of a hydraulic force, a pneumatic force, a mechanical force, and an electromechanical force, for example. Where the force applied at the system inlet 108 is a hydraulic force resulting from the hydraulic pressure of the hybrid system 2, for example, the primary seal 122 allows the piston assembly 112 to be actuated through an application of the hydraulic pressure thereto. It should be appreciated that the piston head 114 may also have a secondary seal 124 disposed thereon that militates against a leakage of hydraulic fluid into an interior of the housing 102. The primary and secondary seals 122, 124 may be in the form of O-rings, although it should be understood that other suitable seal types may also be employed.

In one example, the spring 126 is disposed over the actuating linkage 116. In another example, the spring 126 is disposed adjacent the actuating linkage 116. The spring 126 is selected to bias the piston head 114 toward the first end 104 of the housing 102 when the predetermined minimum pressure of the hybrid system 2 having the retard device 100 is reached. Illustratively, a particular spring constant may be selected so that the spring 126 is sufficient to bias the piston head 114 when the predetermined minimum pressure is reached. As a nonlimiting example for a hydraulic hybrid powertrain system, the spring 126 may be selected to react within a range of about 1000 psi to about 4600 psi. The spring 126 may also be preloaded to a desired level in order to allow the spring 126 to sufficiently bias the piston head 114 when the predetermined minimum pressure is attained. It should be appreciated that suitable springs 126 may include at least one of a compression spring such as a coil spring or a helical spring, and a gas spring, for example. One of ordinary skill in the art may select the spring 126 and the preload, as desired

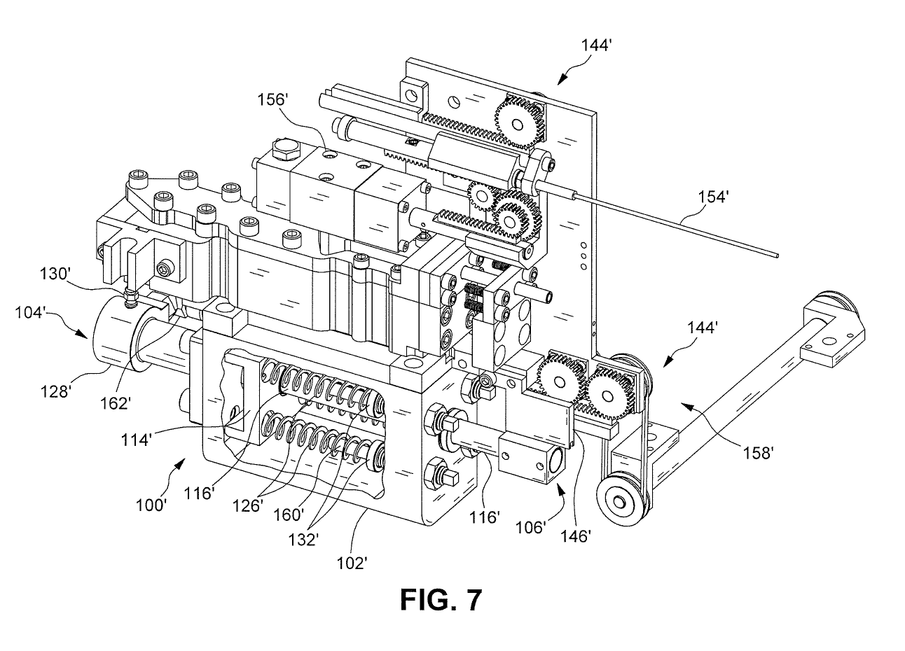

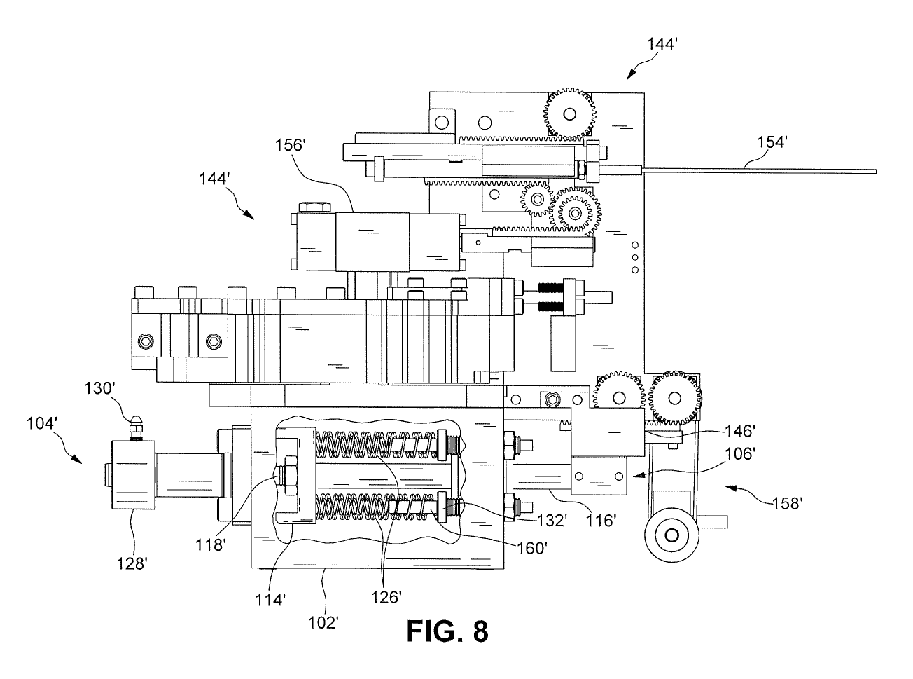

In a further embodiment, the retard device 100 may include an end cap 128 coupled to the first end 104 of the housing 102. The end cap 128 is configured to be placed in fluid communication with a high pressure conduit 162′ (shown in FIG. 7) of the hybrid system 2. It should be appreciated, however, that the end cap 128 may be placed in fluid communication with any portion of the hybrid system 2 where a measurement of the system hydraulic pressure may be obtained. The end cap 128 may also include a bleed valve 130′ (shown in FIGS. 7 and 8) that facilitates a bleeding of hydraulic fluid from the hybrid system 2, as desired.

With renewed reference to FIGS. 4 to 6, the retard device 100 in certain embodiments includes an adjustable spring preload cap 132. The spring preload cap 132 is disposed in the aperture 110 in the second end 106 of the housing 102. The spring preload cap 132 is configured to apply the desired preload to the spring 126. As a nonlimiting example, the adjustable spring preload cap 132 may have a first thread 134 that cooperates with a second thread 136 formed on the inner surface 120 of the housing 102. One of ordinary skill in the art should understand that the preload on the spring 126 disposed in the housing 102 may be adjusted, as desired, by rotating the adjustable spring preload cap 132 in threaded cooperation with the housing 102.

The retard device 100 according to the present disclosure may also include a sleeve bushing 138. The sleeve bushing 138 is disposed between the actuating linkage 116 and the spring preload cap 132. The sleeve bushing 138 is formed from a material that minimizes friction between the spring preload cap 132 and the actuating linkage 116, particularly as the actuating linkage 116 moves through the aperture 110 with operation of the retard device 100. The sleeve bushing 138 may be formed from a self-lubricating, highly wear and corrosion resistant material. As a nonlimiting example, the sleeve bushing 138 may be formed from a self-lubricating oil impregnated sintered metal such Oilite® bronze, commercially available from Beemer Precision, Inc. in Fort Washington, Pa. Other suitable materials for the sleeve bushing 138 may be selected as desired.

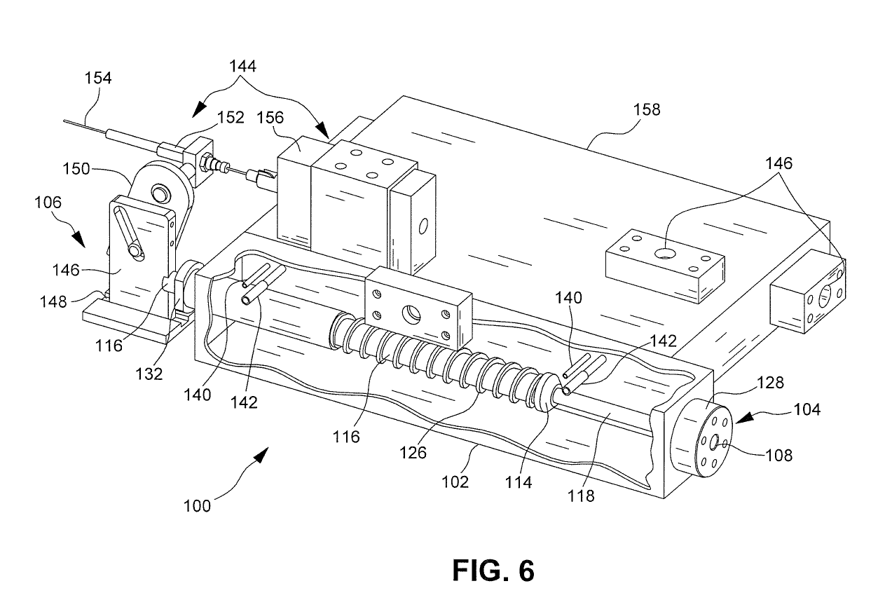

The retard device 100 may be attached directly to the hybrid system 2. As shown in FIGS. 4 and 6, the retard device 100 may include at least one locating pin hole 140 and at least one bolt hole 142 that facilitates the attachment of the retard device 100 to the hybrid system 2. A skilled artisan should appreciate that other means for attaching the retard device 100 to the hybrid system 2 may be employed.

Referring now to FIG. 6, the use of the retard device 100 in a hybrid system 2, such as a hydraulic hybrid powertrain system, is shown. Although the retard device 100 is described herein in relation to the hydraulic hybrid powertrain system, it should be understood that the retard device 100 may be used in any system where the balancing of an input of force and an output of force is desired. For example, the retard device 100 may be used with other types of hybrid powertrain systems. Similarly, the retard device 100 may be employed to improve efficiency in hybrid power systems, such as hybrid wind turbine power systems, hybrid wave and tide power systems, and the like.

The hybrid system 2 includes the at least one drive motor 12. The at least one drive motor 12 is responsive to a fluid flow from at least one of the power plant 4 and the energy store 10, hereinafter referred to as the accumulator 10. A control system 144 is connected to the power plant 4 and the at least one drive motor 12, for example, via at least one inlet or outlet 146. The control system 144 is configured to control an operation of the power plant 4 and the at least one drive motor 12 in a plurality of modes of operation, as is known in the art. For example, the control system 144 operates at least one of the power plant 4 and the drive motor 12 as described by U.S. Pat. No. 7,281,376 to O'Brien II, the entire disclosure of which is hereby incorporated herein by reference.

The system inlet 108 of the retard device 100 is in fluid communication with at least one of the power plant 4 and the accumulator 10. The actuating linkage 116 is operatively coupled to the control system 144. The retard device 100 is configured to reduce the fluid flow to the at least one drive motor 12 when the pressure of the fluid in the hybrid system 2 drops below the predetermined minimum pressure. As should be understood, where hydraulics are employed as part of the hybrid system 2, the force applied at the system inlet 108 is the hydraulic force from the fluid pressure in the hybrid system 2.

In a particular embodiment shown in FIG. 6, the control system 144 includes a sliding plate 146 coupled to the actuating linkage 116. The sliding plate 146 is slidably disposed in a guide groove 148 formed in a surface of the control system 144. The sliding plate 146 is configured to slide with variation in the pressure of the fluid in the hybrid system 2. For example, the piston head 114 will be biased toward one of the first end 104 and the second end 106 by one of the force at the system inlet 108 and the spring 126, as the system fluid pressure changes. The sliding plate 146 has a cam 150 pivotally coupled thereto. The cam 150 is attached to a sheathing 152 through which an accelerator cable 154 is disposed. The accelerator cable 154 is attached at one end to a pedal (not shown) and at another end to an actuator valve 156 on the control system 144. The accelerator cable 154 is employed by an operator in requesting power from the hybrid system 2. The sheathing 152 inhibits the ability of the operator to demand additional power by mechanically limiting the available travel of the accelerator cable 154.

In operation, where the system fluid pressure is greater than the predetermined minimum pressure, the piston head 114 is biased toward the second end 106 and the available travel of the accelerator cable 154 is maximized. Where the system fluid pressure is less than the predetermined minimum pressure, the piston head 114 is biased toward the first end 104 and the available travel of the accelerator cable 154 is minimized. Where the system fluid pressure is less than the predetermined minimum pressure, the retard device 100 effectively and mechanically translates the operator input into a “ramped” demand that is within hybrid system 2 capability, thereby militating against the hydraulic hybrid stall and allowing the power plant 4 to recharge the accumulator 10.

The control system 144 may further include a displacement control module 158. The displacement control module 158 may function as a proportional force multiplier, as is known in the art, for controlling at least one of the engine 6, the pump 8, and the drive motor 12. The displacement control module 158 is operatively coupled with the actuator valve 156, and thereby controlled by the operator via the accelerator cable 154. Although the control system 144 shown in FIG. 6 shows a cam 150 and actuating valve 156 arrangement for controlling the displacement control module 158, it should be further appreciated that gears, hydraulics, pneumatics, electronics, and the like may also be used for controlling the displacement control module 158, within the scope of the present disclosure.

FIGS. 7 and 8 show another embodiment of the instant disclosure. Like structure from FIGS. 4 to 6 have the same reference numeral and a prime (′) for clarity.

The retard device 100′ includes a plurality of the springs 126′ and a plurality of the adjustable spring preload caps 132′. The springs 126′ are disposed between the piston head 114′ and the spring preload caps 132′. The springs 126′ are also disposed adjacent the actuating linkage 116′. For example, the plurality of springs 126′ may be disposed around the actuating linkage 116′ and on spring guides 160′ protruding from the spring preload caps 132′. The plurality of springs 126′ may bias a single piston head 114′, or multiple piston heads 114′, toward the first end 104′ of the housing 102′, as desired.

As further shown in FIGS. 7 and 8, the control system 144′ includes a geared displacement control module 158′ for controlling displacement of the pumps 8 and the drive motors 12 of the hybrid system 2. The geared displacement control module 158′ is configured to directly inhibit the ability of the operator to demand additional power from the hybrid system 2. The sliding plate 146′ is operatively coupled to the geared displacement control module 158′.

In operation, where the system fluid pressure is greater than the predetermined minimum pressure, the piston head 114′ is biased toward the second end 106′ and the sliding plate 146′ allows the operator to request a maximum amount of power from the hybrid system 2. Where the system fluid pressure is less than the predetermined minimum pressure, the piston head 114′ is biased toward the first end 104′ and the sliding plate 146′ inhibits the operator's ability to request power from the hybrid system 2. The retard device 100′ thereby militates against the hydraulic hybrid stall and allows the power plant 4 to recharge the accumulator 10.

It should be appreciated that the retard device 100, 100′ of the present disclosure may operate independent of any electronics in reducing the fluid flow to the at least one drive motor 12, particularly when the pressure of the fluid in the hybrid system 2 drops below the predetermined minimum pressure. Alternatively, the hybrid system 2 may further include an electronic controller (not shown) to further improve fuel efficiency of the hybrid system 2.

The present disclosure further includes a method for operating the hybrid system 2. The retard device 100, 100′ of the present disclosure functions by continuously monitoring system pressure and comparing that value to a predetermined minimum system pressure below which hydraulic hybrid stall is imminent. As the operator demands power to accelerate and the system pressure begins to drop, the retard device 100, 100′ inhibits the ability of the operator to demand more power than the system can provide by mechanically controlling and limiting the relative travel of the accelerator cable. The operator does not sense or feel any “stops” or “detents” in the accelerator pedal movement, but the retard device 100, 100′ effectively and mechanically translates operator input into a “ramped” demand that is within system capability, thus militating against the hydraulic hybrid stall.

The method may further include the steps of selecting the at least one spring 126, 126′ in order to adjust the desired predetermined minimum pressure at which the retard device 100, 100′ actuates to inhibit the hybrid stall. In a further embodiment, the method includes the step of applying the desired preload to the at least one spring 126, 126′, for example, by adjusting the at least one spring preload cap 132, 132′ to provide the desired predetermined minimum pressure at which the retard device 100, 100′ actuates to inhibit the hybrid stall.

Those skilled in the art should appreciate that the retard device 100, 100′ in accordance with the present disclosure may be utilized in any number of hybrid systems 2 including, but not limited to, a propulsion system for a floating or submersible vessel such as a ship a boat, or a submarine, and a propulsion system for a helicopter, among others. The hybrid system 2 of the present disclosure may also be used in static applications such as wind turbines and the like. In short, the present invention may be used in any system where efficient management of energy inputs and outputs is desired.

While certain representative embodiments and details have been shown for purposes of illustrating the invention, it will be apparent to those skilled in the art that various changes may be made without departing from the scope of the disclosure, which is further described in the following appended claims.

What is claimed is:

1. A retard device, comprising:
a housing having a first end and a second end, the first end having a system inlet and the second end having an aperture;
a piston assembly slidably disposed in the aperture of the housing, the piston assembly including a piston head coupled to an actuating linkage, the piston head disposed adjacent the system inlet and the actuating linkage disposed through the aperture of the housing; and
a spring disposed within the housing between the second end and the piston head, wherein the piston head is biased toward the first end by the spring and biased toward the second end by a force applied at the system inlet.

2. The retard device of claim 1, furthering including an end cap coupled to the first end of the housing, the end cap configured to be placed in fluid communication with a high pressure conduit.

3. The retard device of claim 2, wherein the end cap includes a bleed valve.

4. The retard device of claim 1, further including an adjustable spring preload cap disposed in the aperture in the second end of the housing, the spring preload cap configured to apply a desired preload to the spring.

5. The retard device of claim 4, wherein the adjustable spring preload cap has a first thread cooperating with a second thread formed on an inner surface of the housing.

6. The retard device of claim 4, further including a sleeve bushing disposed between the actuating linkage and the spring preload cap.

7. The retard device of claim 1, further including a push rod coupled to the piston and disposed in the system inlet, the push rod sealingly engaged with the housing.

8. The retard device of claim 7, further including at least one seal disposed between the push rod and an inner surface of the housing.

9. The retard device of claim 1, wherein the spring is disposed over the actuating linkage.

10. The retard device of claim 1, including a plurality of springs and a plurality of adjustable spring preload caps, the springs disposed between the piston and the spring preload caps and disposed adjacent the actuating linkage, the plurality of springs biasing the piston toward the first end.

11. The retard device of claim 1, wherein the force applied at the system inlet is provided by a system fluid pressure.

12. A hydraulic hybrid powertrain system, comprising:
at least one drive motor responsive to the fluid flow from at least one of a power plant and an accumulator;
a control system connected to the power plant and the at least one drive motor for controlling operation of the power plant and the at least one drive motor in a plurality of modes of operation; and
at least one retard device including a housing having a first end and a second end, the first end having a system inlet and the second end having an aperture, the system inlet in fluid communication with at least one of the power plant and the accumulator, a piston assembly slidably disposed in the aperture of the housing, the piston assembly including a piston head coupled to an actuating linkage, the piston head disposed adjacent the system inlet and the actuating linkage disposed through the aperture of the housing, the actuating linkage operatively coupled to the control system, and a spring disposed within the housing between the second end and the piston head, wherein the piston head is biased toward the first end by the spring and biased toward the second end by a force applied at the system inlet,
wherein the retard device reduces the fluid flow to the at least one drive motor when the pressure of the fluid in the hydraulic hybrid powertrain system drops below a predetermined minimum pressure.

13. The hydraulic hybrid powertrain system of claim 12, wherein the force applied at the system inlet is provided by a fluid pressure in the hydraulic hybrid powertrain system.

14. The hydraulic hybrid powertrain system of claim 12, wherein the control system includes a sliding plate coupled to the actuating linkage, the sliding plate configured to slide with variation in the pressure of the fluid in the hydraulic hybrid powertrain system.

15. The hydraulic hybrid powertrain system of claim 14, wherein the sliding plate has a cam pivotally coupled thereto, the cam attached to a sheathing through which an accelerator cable is disposed, the sheathing inhibiting the ability of an operator to demand additional power by mechanically limiting the available travel of the accelerator cable.

16. The hydraulic hybrid powertrain system of claim 15, wherein the accelerator cable is connected to an actuator valve for the control system.

17. The hydraulic hybrid powertrain system of claim 14, wherein the control system includes a geared displacement control module configured to directly inhibit the ability of an operator to demand additional power from the hydraulic hybrid powertrain system, the sliding plate operatively coupled to the geared displacement control module.

18. The hydraulic hybrid powertrain system of claim 12, wherein the retard device operates independent of any electronics in reducing the fluid flow to the at least one drive motor when the pressure of the fluid in the hydraulic hybrid powertrain system drops below the predetermined minimum pressure.

19. The hydraulic hybrid powertrain system of claim 12, further including an electronic controller to further improve fuel efficiency.

20. A method for operating a hybrid system, the method comprising the steps of:
continuously monitoring a pressure of a fluid in the hybrid system, the hybrid system having an at least one drive motor responsive to a fluid flow from at least one of a power plant and an accumulator, a control system connected to the power plant and the at least one drive motor for controlling operation of the power plant and the at least one drive motor in a plurality of modes of operation, and a retard device;
comparing the pressure of the fluid in the hybrid system to a predetermined minimum pressure;
inhibiting an ability of an operator to demand more power than the hybrid system can provide without stalling by reducing the fluid flow to a drive motor when the predetermined minimum pressure is achieved; and
allowing the pressure of the fluid in the hybrid system to recover, wherein a hybrid stall is militated against.
